(19) United States
(12) Patent Application Publication
(10) Pub. No.: US 2004/0190869 A1
(43) Pub. Date: Sep. 30, 2004

(54) Navigation device

(75) Inventor: Chi Nan Chou, Taipei (TW)

Correspondence Address: BROWDY AND NEIMARK, P.L.L.C., 624 NINTH STREET, NW, SUITE 300, WASHINGTON, DC, 20001-5303, US

(73) Assignee: BCOM ELECTRONICS Inc., Hsi Chih City (TW)

(21) Appl. No.: 10/401,726

(22) Filed: Mar. 31, 2003

(51) Int. Cl. H04N 5/781

(52) U.S. Cl. 386/95; 386/125

(57) ABSTRACT

A navigation device equipped with an optical media player for reading an audio/video-formatted (AV-formatted) disc and a map information disc and a display device for displaying contents of the AV-formatted disc and map information thereon is provided. The navigation device includes a processing unit connected to the optical media player for controlling the optical player to read an image data and an audio data from the AV-formatted disc, an image decoding unit connected to the processing unit for decoding the image data to generate an image signal and display the image signal onto the display device, an audio decoding unit connected to the processing unit for decoding the audio data to generate an audio signal having at least one audio channel, and an audio outputting unit connected to the audio decoding unit for outputting the audio signal.

### BACKGROUND OF THE INVENTION

1. Field of the Invention

The present invention relates to a navigation device, and more particularly, to a navigation device incorporating the regular audio/video-formatted (AV-formatted) disc broadcasting function therein.

2. Description of the Prior Art

With the evolution of technology, at the present time, many vehicles are equipped with satellite navigation devices, so as to provide the real-time information regarding where the current location is, which route is the fastest route from the current location to the destination (given the traffic congestion factor), and so on, to the drivers. However, traditional navigation devices unavoidably have to cooperate with at least one satellite antenna for communicating with satellites in the orbits, thereby locating where the current position is and displaying correspondingly visualized information, including the maps stored in the navigation devices previously, on the display devices. These maps and corresponding information are usually stored in terms of some optical media. Given the characteristic of the map information, always taking very much storage capacity, and from the standpoint of easy expansion and refreshment, storing the map information into these optical media appears most convenient at the present time. Thus, these navigation devices are equipped with DVD-ROMs, and maps and other corresponding information are stored in terms of DVD-formatted discs accordingly, because the DVD-formatted disc has a relatively larger storage capacity in one disc unit than that of CD-, or VCD-formatted discs.

Please refer to FIG. 1 of illustrating a hardware architecture block diagram according to a prior art navigation device. The optical media player 2 equipped with the prior art navigation device 1 is adapted to read the map information disc 10 and display the map information stored in the disc 10 on the display device 3, instead of reading DVD-formatted audio/video discs, due to there is no corresponding hardware/firmware, such as MPEG-2 decoders, configured in the navigation device 1 for reading DVD-formatted discs. Besides, traditional optical media players are unable to connect to navigation devices, and sometimes, unable to read the map information discs, resulting in that either the optical media player or navigation device only has its own functions and is seemingly impossible to be integrated with each other.

### SUMMARY OF THE INVENTION

It is therefore a primary objective of the present invention to provide a navigation device equipped with an optical media player for reading an audio/video-formatted (AV-formatted) disc and a map information disc and a display device for displaying contents of the AV-formatted disc and the map information thereon. The navigation device includes a processing unit connected to the optical player for controlling the optical player in order to read image and audio data from the AV-formatted disc, an image decoding unit connected to the processing unit for decoding the image data to generate an image signal and display the image signal onto the display device, an audio decoding unit connected to the processing unit for decoding the audio data to generate an audio signal having at least one audio channel, and an audio outputting unit connected to the audio decoding unit for outputting the audio signal.

It is an advantage of the present invention that the navigation device incorporates the function of playing AV-formatted discs therein, in addition to the function of reading and displaying the map information. Besides, the navigation device according to the present invention further includes a memory unit for storing the map information, in order to execute the function of vehicle navigation based on the map information at the same time of reading the AV-formatted discs. Still, the present invention further includes a human/machine interface, so as to allow the user to manipulate the optical media player for controlling functions of playing, stopping, volume adjusting, pausing, muting, and switching for the optical media player.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of illustrating the hardware architecture of a prior art navigation device.

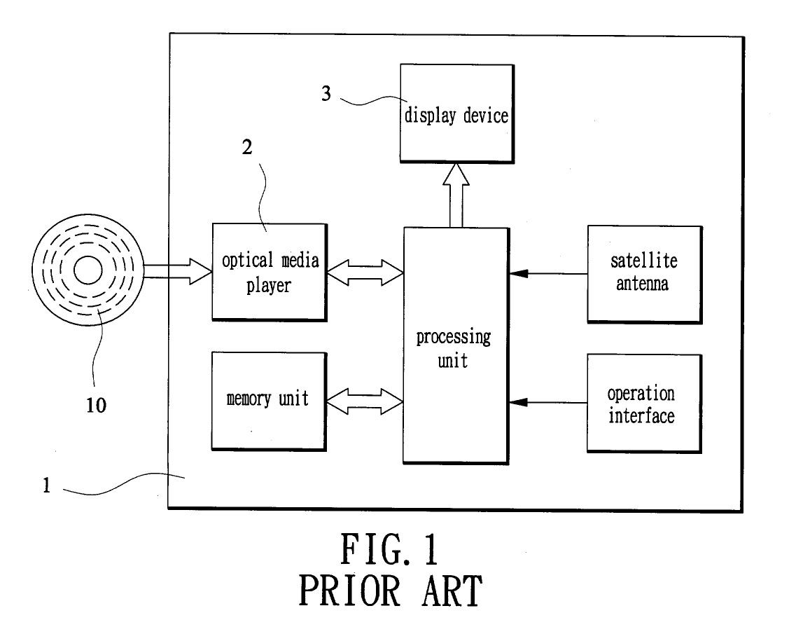

FIG. 2 is a circuit block diagram of the navigation device according to the present invention.

FIG. 3 is a flow chart of illustrating the navigation device of the present invention under the mode of navigation.

FIG. 4 is a flow chart of illustrating the navigation device of the present invention under the mode of playing AV-formatted discs.

### DETAILED DESCRIPTION OF THE PREFERRED EMBODIMENT

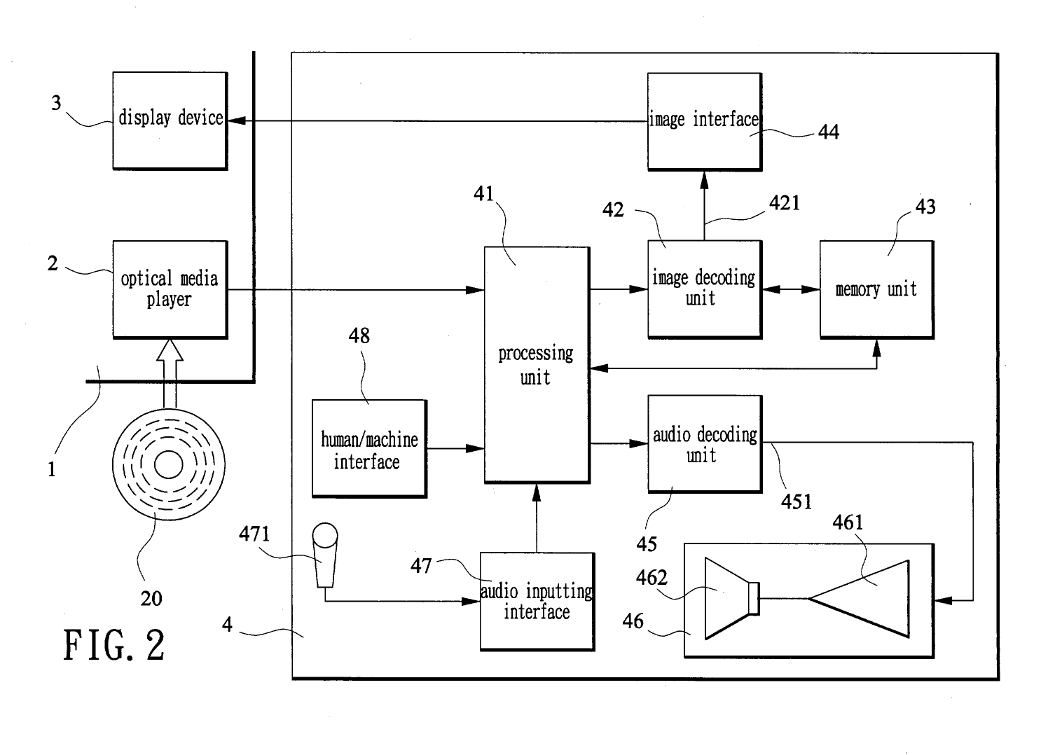

Please refer to FIG. 2 of illustrating a circuit block diagram of the navigation device according to the present invention. The navigation device 1 is equipped with an optical media player 2, such as a VCD or DVD player, in order to read an AV-formatted disc 20 and display image and audio data thereof on the display device 3. The AV-formatted disc 20 is selected from a group consisting of a DVD-, VCD-, SVCD-, CD-, or MP3-formatted disc; and the display device 3 is selected from a group consisting of a LCD or CRT television display device.

The present invention navigation device 1 further includes an AV broadcasting device 4 including a processing unit 41, an image decoding unit 42, a memory unit 43, an image interface 44, an audio decoding unit 45, an audio outputting unit 46, an audio inputting interface 47, and a human/machine interface 48. The processing unit 41 is connected to the optical media player 2 for controlling the optical media player 2 to read the image or audio data of map information disc 10 or AV-formatted disc 20 out simultaneously, and then send these data to the image decoding unit 42 and audio decoding unit 45.

The image decoding unit 42 is connected to the processing unit 41 for decoding the image data, such as the MPEG-1- or MPEG-2-coded image data, of the AV-formatted disc 20, so as to generate corresponding image signals 421. However, the decoding rate of the image decoding unit 42 is faster than the displaying rate of these image data, thus, the memory unit 43 is employed to temporarily store the image data and have these stored image data to be decoded by the image decoding unit 42 thereafter.

As the image decoding unit 42 decodes these image data into corresponding image signals 421, the image interface 44, connected to the image decoding unit 42 and display device 3, further converts these image signals 421 into display signals compatible with the display device 3, in order to have these display signals displayed on the display device 3.

The audio decoding unit 45 is connected to the processing unit 41 also, for decoding audio data from the optical player 2, so as to generate audio signals 451 including at least one audio channel. These audio data are selected from a group consisting of MPEG-, AC3-, DTS-, DOLBY-, or MP3-coded audio data. The audio outputting unit 46 further- connects to the audio decoding unit 45 for outputting the audio signals 451.

The audio outputting unit 46 further includes an audio amplifier 461 and at least one speaker 462. Given the likelihood that the audio data are multi-channel audio data, the audio amplifier 461 includes several audio outputting ends for amplifying audio signals 451 decoded by the audio decoding unit 461; meanwhile, each speaker 462 is connected to each of these audio outputting ends of the audio amplifier 461, in order to output these multi-channel audio signals 451.

Additionally, the present invention further includes an audio inputting interface 47 connected to the processing unit 41, wherein the audio inputting interface 47 can be connected to at least one microphone. 471, so as to allow users to use the microphone 471 at the same time the AV-formatted discs are played, thereby providing another function to users.

The present invention further includes a human/machine interface 48 connected to the processing unit 41, for allowing users to manipulate the optical media player 2 to perform functions of reading, broadcasting, or stopping for the optical media player 2. The human/machine interface 48 also connects to the audio outputting unit 46 and has a plurality of control buttons thereon for the purpose of allowing users to adjust the volume of this audio outputting unit 46. Therefore, control buttons include functions of playing, stopping, volume adjusting, pausing, muting, and switching for the optical media player 2. The function of switching is for alternatively. having the optical media player 2 switched between modes of reading the AV-formatted disc 20 and reading the map information disc 10.

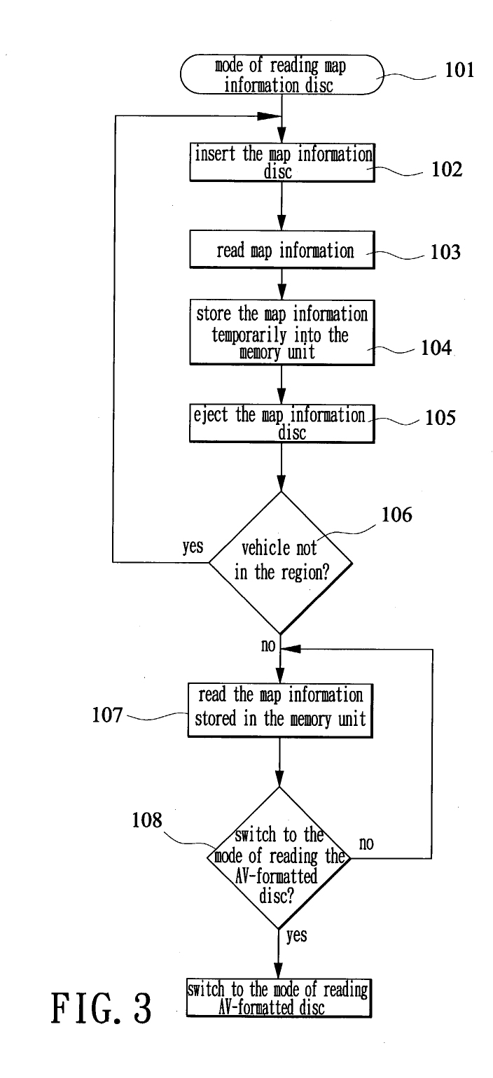

Please refer to FIG. 3 of illustrating a flow chart of the navigation of the present invention navigation device. For the purpose of allowing the present invention navigation device to incorporate the function of navigation at the same time of playing the AV-formatted disc 20 therein, the volume of memory unit 43 is increased and the data reading process for the navigation device 1 is changed accordingly. As the navigation device 1 is operated under the mode of reading map information, the map information disc 10 is placed into the optical player 2 (step 102), and then the map information for the current region stored in the map information disc is stored into the memory unit 43 (step 104). Once the vehicle is not within the region, another map information disc has to be inserted into the optical player 2; once the vehicle is still in the region, the map information can be directly read from the memory unit 43. (step 107) and the navigation device 1 can be switched into the mode of reading AV-formatted disc (step 108).

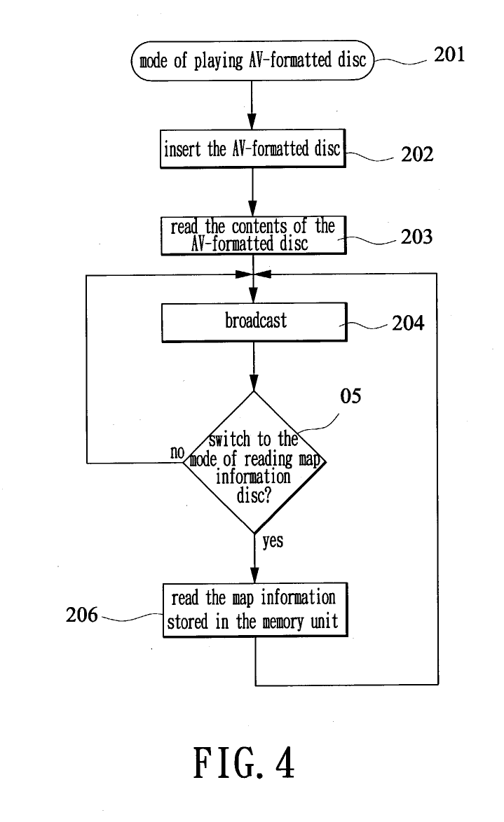

Please refer to FIG. 4 of illustrating a flow chart of having the present invention navigation device playing AV-formatted discs. As the navigation device is under the mode of playing AV-formatted discs, AV-formatted discs 20 are placed into the optical player 2 (step 202), and then the processing unit 41 reads the image and audio data from the AV-formatted discs (step 203), which are displayed onto the display device 3 or outputted to the audio outputting unit 46 (step 204). If any vehicle navigation is required at the same time of playing AV-formatted discs, switching the control button of switching function (step 205) will have the navigation device enter the mode of map information reading, then output the map information previously stored in the memory unit 43 (step 206), and then return to the mode of playing AV-formatted discs, in order to play the AV-formatted discs and map information discs simultaneously.

In contrast to prior arts, the navigation device based on the present invention further incorporates the function of playing AV-formatted discs. Under the configuration according to the present invention, the provided navigation device may switch the operation mode thereof between reading the map information and reading the AV-formatted information. Thereby, the navigation device according to the present invention not limits itself to the function of navigation, but also provides another function of reading AV-formatted information at the same time.

Those skilled in the art will readily observe that numerous modifications and alterations of the device may be made while retaining the teachings of the invention. Accordingly, the above disclosure should be construed as limited by metes and bounds of the appended claims.

What is claimed is:

1. A navigation device equipped with an optical media player for reading an audio/video-formatted (AV-formatted) disc and a map information disc and a display device for displaying contents of said AV-formatted disc and said map information disc thereon, said navigation device comprising:
a processing unit connected to said optical player for controlling said optical media player to read an image data and an audio data from said AV-formatted disc;
an image decoding-unit connected to said processing unit for decoding said image data to generate an image signal and display said image signal onto said display device;
an audio decoding unit connected to said processing unit for decoding said audio data to generate an-audio signal having at least one audio channel; and
an audio outputting unit connected to said audio decoding unit for outputting said audio signal.

2. The navigation device of claim 1, further comprising a memory unit connected to said image decoding unit for temporarily storing said image data, so as to have said image data decoded by said image decoding unit.

3. The navigation device of claim 2, wherein said memory unit is for storing contents of said map information disc, so as to navigate the users at the same time that said optical player reads said image or audio data from said AV-formatted disc.

4. The navigation device of claim 1, further comprising an image interface connected to said image decoding unit and said display device, so as to convert said image signal into a display signal compatible with said display device.

5. The navigation device of claim 1, further comprising an audio inputting interface connected to said processing unit, wherein said audio inputting interface further connects to a microphone.

6. The navigation device of claim 1, further comprising a human/machine interface connected to said processing unit for allowing users to manipulate said optical player.

7. The navigation device of claim 6, wherein said human/machine interface further connects to said audio- outputting unit, so as to allow users to adjust the audio volume of said optical media player.

8. The navigation device of claim 6, wherein said human/machine interface further comprises a plurality of control buttons thereon, wherein said control buttons-include functions of playing, stopping, volume adjusting, pausing, muting, and switching for said optical media player.

9. The navigation device of claim 8, wherein said control button with the function of switching is for allowing said optical media player to switch from reading said AV-formatted disc to reading said map information disc or vice versa.

10. The navigation device of claim 1, wherein said optical media player is a DVD player or a VCD player.

11. The navigation device of claim 1, wherein said AV-formatted disc is selected from a group consisting of a DVD-, VCD-, SVCD-, CD-, and MP3-formatted disc.

12. The navigation device of claim 1, wherein said display device is a LCD or a CRT television.

13. The navigation device of claim 1, wherein said image decoding unit is for decoding MPEG-1- or MPEG-2-coded data.

14. The navigation device of claim 1, wherein said audio decoding unit is for decoding MPEG-, AC3-, DTS-, DOLBY-, or MP3-coded data.

15. The navigation device of claim 1,wherein said audio outputting unit comprises an audio amplifier having at least one audio channel end for amplifying said audio signal decoded by said audio decoding unit, and at least one speaker connected to said audio channel end of said audio amplifier for having said audio signal outputted.
